(19) United States
(12) Patent Application Publication
(10) Pub. No.: US 2007/0229796 A1
(43) Pub. Date: Oct. 4, 2007

(54) OPTICAL RANGE FINDER

(75) Inventors: Chieh-Jen Lee, Taichung County (TW); Shu-Hung Lin, Taichung County (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: ASIA OPTICAL CO., INC., Taichung (TW)

(21) Appl. No.: 11/760,115

(22) Filed: Jun. 8, 2007

Related U.S. Application Data
(62) Division of application No. 10/927,983, filed on Aug. 27, 2004.

(30) Foreign Application Priority Data
Sep. 10, 2003 (TW) 92124985

(51) Int. Cl. G01C 3/00

(52) U.S. Cl. 356/4.01

(57) ABSTRACT

An optical range finder measuring distance to a target and capturing the image of the target simultaneously is provided. The optical range finder includes an emitting system emitting a pulse toward the target and a receiving system receiving the pulse reflected from the target, to calculate the distance there between. The emitting system or the receiving system includes a beam splitter for separating the visible beam of the target from the pulse, and the visible beam of the target is received by an image sensor. Thus, the optical range finder measures the distance and captures the image of the target. Moreover, the optical range finder further includes a display showing the captured image and distance data.

### CROSS-REFERENCE TO RELATED APPLICATION

The present application is a division of U.S. patent application Ser. No. 10/927,983, filed Aug. 27, 2004, the contents of which are incorporated by reference herein.

### FIELD OF THE INVENTION

The present invention relates to an optical range finder, especially an optical range finder obtaining an image simultaneously.

### PRIOR ART

FIG. 1 schematically shows a conventional optical range finder disclosed in U.S. Pat. No. 6,441,887. The optical range finder 1 includes an emitting system 2, a telescope system 3 and a receiving system 4. Referring to FIG. 1, after the emitting system 2 emits a light beam toward the target by the telescope system 3, the target reflects the light beam. Then, the reflected light beam enters the receiving system 4.

However, this optical range finder can not capture the image of the target.

### SUMMARY OF THE INVENTION

The optical range finder of the present invention includes a receiving/emitting system and a telescope/image-capturing system. The receiving/emitting system, which includes a beam splitter, emits a beam toward a target, and the reflected beam from the target is received by a photodetector via the beam splitter. The telescope/image-capturing system observes the image of the target and captures it.

Another optical range finder of the present invention includes an emitting system, a receiving system and an image-capturing device. The emitting system emits a beam toward a target and the target reflects the beam to the receiving system. At the same time, the visible light of the target enters the receiving system. In the receiving system, a beam splitter separates the reflected beam and the visible light from the target. Thus, the reflected beam is received by a photodetector and the visible light of the target is captured by the image-capturing device.

Another optical range finder of the present invention includes an emitting system, a receiving system and an image-capturing device. The emitting system emits a beam toward a target and the target reflects the beam to the receiving system. At the same time, the visible light of the target enters the emitting system. In the emitting system, a beam splitter separates the beam from an emitting device and the visible light from the target. Finally, the visible light of the target is captured by the image-capturing device.

The receiving/emitting system uses one object lens via the first beam splitter, and the telescope/image-capturing system uses another objective lens via the second beam splitter.

The receiving system and the image-capturing device use the same object lens, by utilizing a beam splitter.

The foregoing and additional features and advantages of the invention will be more readily apparent from the following detailed description, which proceeds with reference to the accompanying drawings.

### BRIEF DESCRIPTION OF THE DRAWINGS

FIG. 1 schematically shows a conventional optical range finder disclosed in U.S. Pat. No. 6,441,887;

FIG. 2 schematically shows an optical range finder of the first embodiment of the present invention;

FIG. 3 schematically shows an optical range finder of the second embodiment of the present invention;

FIG. 4 schematically shows a variation of the optical range finder of the second embodiment;

FIG. 5 schematically shows an optical range finder of the third embodiment of the present invention;

FIG. 6 schematically shows a variation of the optical range finder of the third embodiment; and

FIGS. 7A to 7C schematically show a display, disposed outside of or inside the optical range finder of embodiments of the invention.

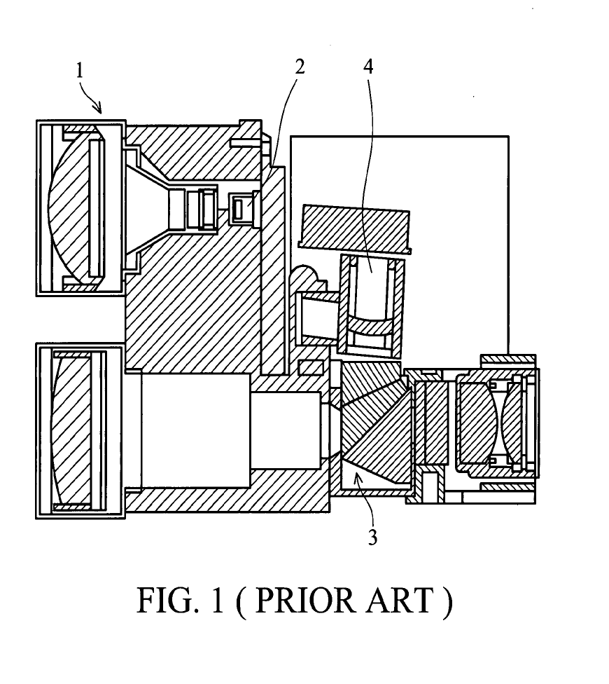

### DESCRIPTION OF THE INVENTION

### First Embodiment

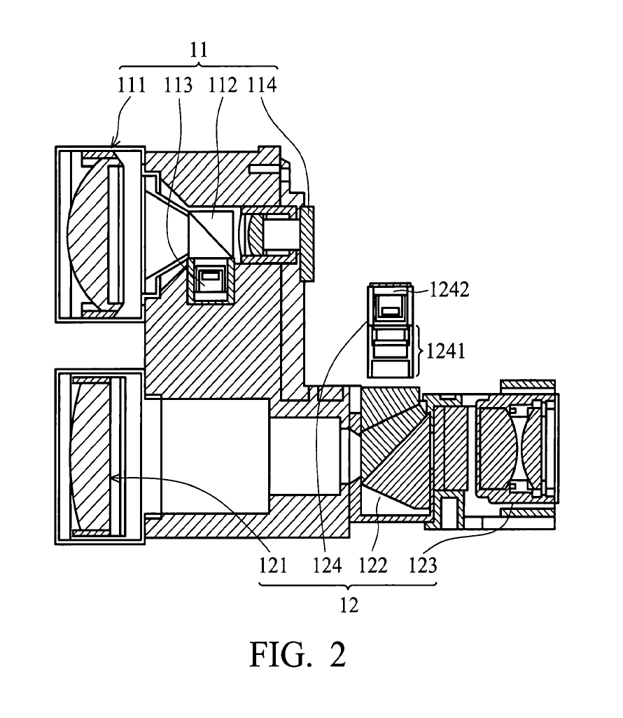

FIG. 2 schematically shows an optical range finder of the first embodiment of the present invention. The optical range finder 10 includes a receiving/emitting system 11 and a telescope/image-capturing system 12. As shown in FIG. 2, the receiving/emitting system 11 includes a first object lens 111, a first beam splitter 112, an emitting device 113 and a photodetector 114. The emitting device 113 can be a laser diode or a LED, and the photodetector 114 can use an Avalanche Photodiode (APD). The telescope/image-capturing system 12 includes a second object lens 121, a second beam splitter 122, an ocular lens 123 and an image-capturing unit 124. The image-capturing unit 124 further includes a lens group 1241 and an image sensor 1242, such as a CCD or a CMOS.

Referring to FIG. 2, in the emitting/receiving system, the emitting device 113 emits a beam, such as a laser diode emitting an infrared pulse of 905 nm. The pulse is reflected by the first beam splitter 112 and then collimated by the first object lens 111, to travel toward the target. The first beam splitter 112 can be a prism or a filter, wherein 50% of the pulse is reflected and the other 50% passes. Next, the target reflects the pulse, and a portion of the reflected pulse passes through the first object lens 111 to re-enter the emitting/receiving system 11. The reflected pulse passes the first beam splitter 112 and is finally received by the photodetector 114. A circuit calculates the distance between the target and the optical range finder.

Referring to FIG. 2, the visible light of the target enters the telescope/image-capturing system 12 via the second object lenses 121, and is then divided into a first visible beam and a second visible beam by the second beam splitter 122. The image sensor 124 receives the first visible beam to obtain the image of the target. The second visible beam forms a viewable image by the ocular lens 123.

In the first embodiment of the present invention, utilizing the telescope/image-capturing system 12, the image of the target viewed through the ocular lens 123 is completely equal to that captured by the image sensor 124. Thus, about 50% intensity of the image beam is received by the image sensor 124. Moreover, the infrared pulse passes through the first beam splitter twice, such that 75% intensity or more is lost.

### Second Embodiment

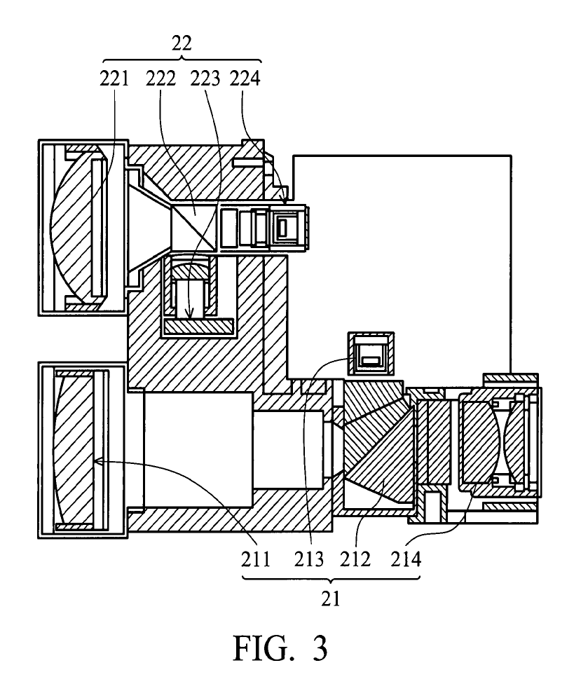

FIG. 3 schematically shows an optical range finder of the second embodiment of the present invention. The optical range finder 20 includes an emitting/telescope system 21 and a receiving/image-capturing system 22. As shown in FIG. 3, the emitting/telescope system 21 includes a first object lens 211, a first beam splitter 212, a light source 213 and an ocular lens 214, wherein the light source 213 can be a laser diode or LED. The receiving/image-capturing system 22 includes a second object lens 221, a second beam splitter 222, a photodetector 223 and an image-capturing unit 224, wherein the photodetector 223 can be an Avalanche Photodiode (APD). In addition, the image-capturing unit 224 includes an imaging lens 2241 and an image sensor 2242, wherein the image sensor 2242 can be a CCD or a CMOS.

Referring to FIG. 3, in the emitting/telescope system 21, the light source 213 emits a pulse, such as a laser diode emitting an infrared pulse of 905 nm. The infrared pulse is reflected by the first beam splitter 212 and then collimated by the first object lens 111, to travel toward the target. The first beam splitter 212 can be a prism or a filter, and reflects the pulse. Next, the target reflects the infrared pulse, and a portion of the reflected pulse enters the receiving/image-capturing system 22 via the second object lens 211. In the receiving/image-capturing system 22, the reflected pulse is reflected to the photodetector 223 via the second beam splitter 222. A circuit calculates the distance between the target and the optical range finder.

Referring to FIG. 3, the visible beam of the target enters the emitting/telescope system 21 and the receiving/image-capturing system 22 via the first object lenses group 211 and the second object lens group 221 respectively. In the emitting/telescope optical system 21, the visible beam of the target passes through the first beam splitter 212 and projects a viewable image by the ocular lens 214. In the receiving/image-capturing system 22, after passing the second beam splitter 222, the image sensor 224 receives the visible beam to obtain the image of the target.

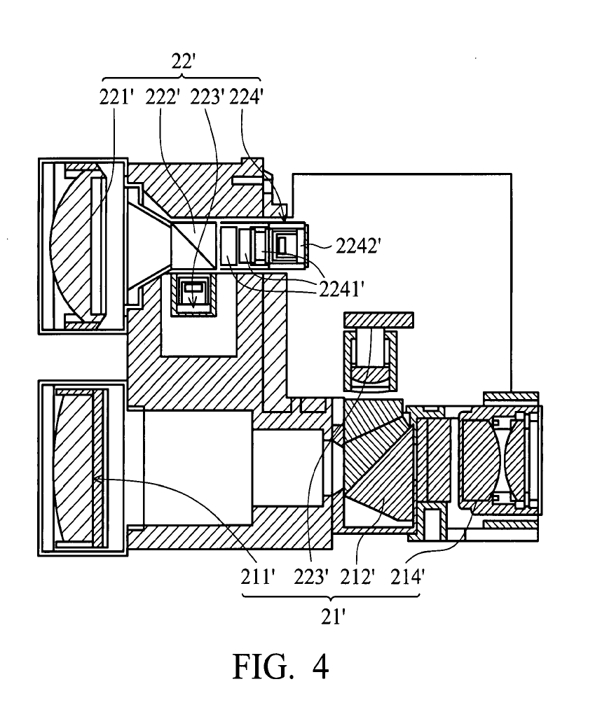

FIG. 4 schematically shows a variation of the optical range finder of the second embodiment. The optical range finder 20′ includes a receiving/telescope system 21′ and an emitting/image-capturing system 22′. In FIG. 4, the pulse is emitted from the emitting/image-capturing system 22′, and reflected by the target to enter the receiving/telescope system 21′. In addition, the target is viewed through the receiving/telescope system 21′ and the image of the target is captured by the emitting/image-capturing system 22′.

### Third Embodiment

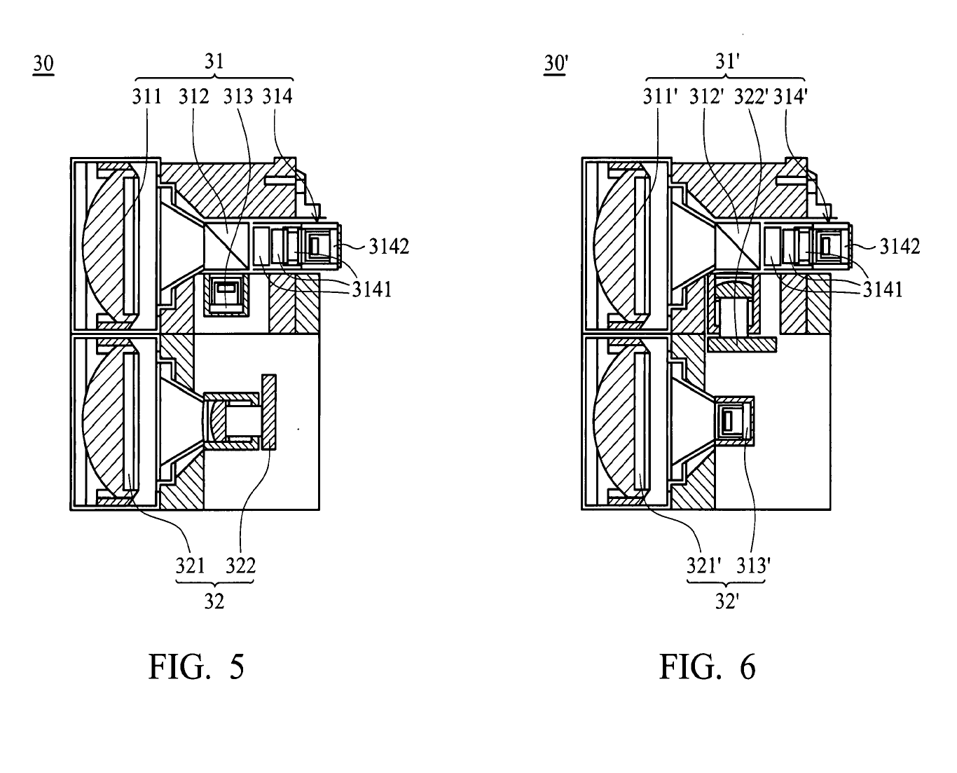

FIG. 5 schematically shows an optical range finder of the third embodiment of the present invention. The optical range finder 30 includes an emitting/image-capturing system 31 and a receiving system 32. As shown in FIG. 5, the emitting/image-capturing system 31 includes a first object lens 311, a first beam splitter 312, a light source 313 and an image sensor 314. The receiving system 32 includes a second object lens 321 and a photodetector 322.

Referring to FIG. 5, in the emitting/image-capturing system 31, the light source 313 emits pulse light, such as a laser diode emitting an infrared pulse beam of 905 nm. The infrared pulse is reflected by the first beam splitter 312 and then collimated by the first object lens 311, to travel toward the target. The first beam splitter 312 can be a prism or a filter, and reflects the pulse. Next, the target reflects the pulse, and a portion of the reflected pulse enters the receiving system 32 via the second object lens 321. The reflected pulse is received by the photodetector 322 in the receiving system 32. A circuit calculates the distance between the target and the optical range finder according to the pulse.

Referring to the FIG. 5, the visible beam of the target enters the emitting/image-capturing system 31 via the first object lens 311. In the emitting/image-capturing system 31, the visible beam of the target passes the first beam splitter 312 and is received by the image sensor 314 to obtain the image of the target.

FIG. 6 schematically shows a variation of the optical range finder of the third embodiment. The optical range finder includes a receiving/image-capturing system 31′ and an emitting system 32′. In FIG. 6, the pulse is emitted from the emitting system 32′, reflected by the target and received, by the receiving/image-capturing system 31′. The image of the target is obtained by the emitting/image-capturing system 31′.

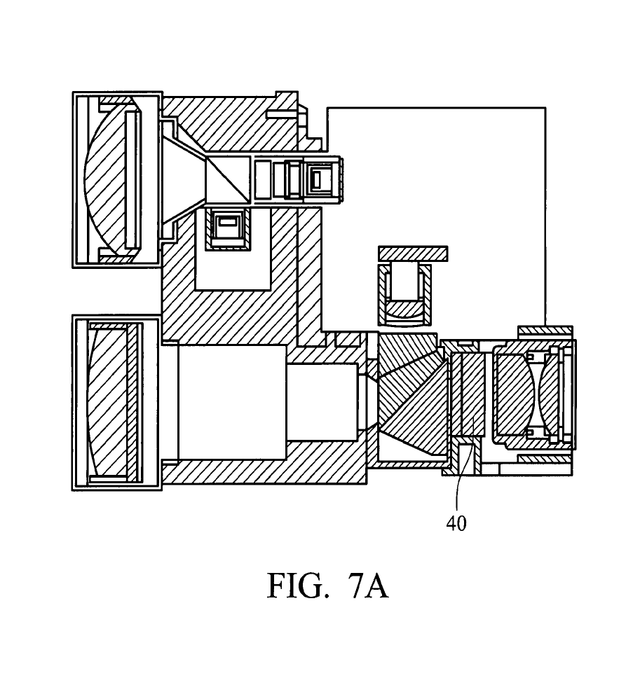

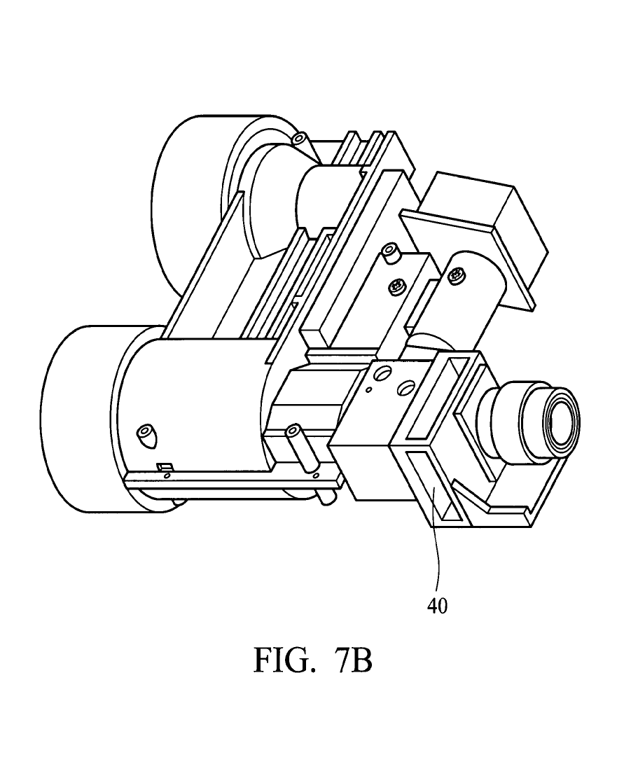

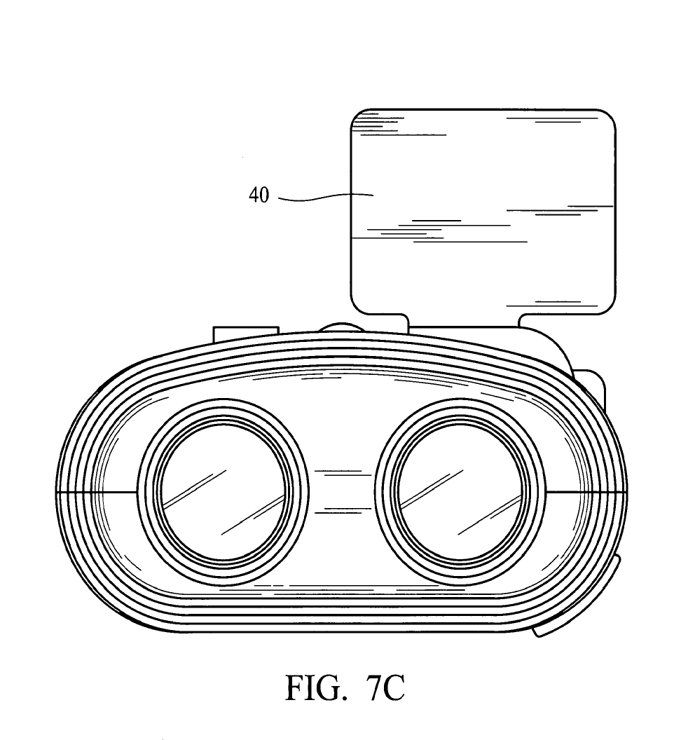

FIGS. 7A to 7C schematically show a display of the optical range finder of the present invention. As shown in FIGS. 7A to 7C, the display shows the measured distance and the captured image. The display can be disposed inside or outside of the optical range finder.

What is claimed is:

1. An optical range finder for measuring the distance of a target, comprising:
an emitting/receiving system emitting a pulse toward the target and receiving the pulse reflected therefrom to calculate the distance between the target and the optical range finder; and
a telescope/image-capturing system observing the target and capturing the image of the target.

2. The optical range finder as claimed in claim 1, wherein the emitting/receiving system further comprises:
an emitting device emitting the pulse;
a first beam splitter reflecting the pulse from the emitting device;
a first object lens collimating the pulse to the target and guiding the pulse reflected by the target to the first beam splitter; and
a receiving device receiving the pulse reflected by the target and passing the first beam splitter.

3. The optical range finder as claimed in claim 1, wherein the emitting/receiving system further comprises:
an emitting unit emitting the pulse;
a first beam splitter passing the pulse therethrough;
a first object lens collimating the pulse to the target and guiding the pulse reflected by the target to the first beam splitter; and
a receiving device receiving the pulse reflected by the first beam splitter.

4. The optical range finder as claimed in claim 2, wherein the telescope/image-capturing system comprises:
a second object lens;
an ocular lens;
a second beam splitter disposed between the second object lens and the ocular lens; and
an image-capturing unit;
wherein the visible beam of the target passing the second object lens is delivered respectively to the ocular lens and the image-capturing unit by the second beam splitter.

5. The optical range finder as claimed in claim 3, wherein the telescope/image-capturing system comprises:
a second object lens;
an ocular lens;
a second beam splitter disposed between the second object lens and the ocular lens; and
an image-capturing unit;
wherein the visible beam of the target passing the second object lens is delivered respectively to the ocular lens and the image-capturing unit by the second beam splitter.
